(19) United States
(12) Patent Application Publication
(10) Pub. No.: US 2018/0194341 A1
(43) Pub. Date: Jul. 12, 2018

(54) HYBRID ELECTRIC VEHICLE CONTROLLER AND METHOD

(71) Applicant: Jaguar Land Rover Limited, Coventry (GB)

(72) Inventors: Simon Owen, Coventry (GB); John Hogley, Coventry (GB)

(21) Appl. No.: 15/504,883

(22) PCT Filed: Aug. 18, 2015
(86) PCT No.: PCT/EP2015/068967

§ 371 Date: Feb. 17, 2017

(30) Foreign Application Priority Data
Aug. 18, 2014 (GB) 1414585.8

(51) Int. Cl. B60W 20/13; B60W 10/04; B60W 10/26; B60W 30/18; B60W 10/18; B60W 10/20; B60W 10/22; B60W 30/02

(52) U.S. Cl. CPC B60W 20/13; B60K 6/48; B60W 10/26; B60W 30/18054; B60W 10/18; B60W 10/20; B60W 10/22; B60W 30/02; B60W 2540/12; B60W 2520/04; B60W 2510/244; B60W 2540/30; B60W 2510/10; B60W 2540/10; B60W 2710/244; B60W 2710/0644; B60W 2710/08; B60W 2710/18; B60W 2710/20; B60W 2710/22; B60W 2720/14; Y10S 903/93; B60W 10/04

(57) ABSTRACT

Some embodiments of the present invention provide a controller for a hybrid electric vehicle comprising: charging command means for causing an engine-driven electrical generator to generate charge to charge a propulsion charge storage device; means for determining when a vehicle is stationary; means for determining when a user has commanded application of a brake to hold a vehicle stationary; and means for determining when a transmission is in a predetermined one or more operating conditions in which the transmission is configured to deliver drive torque to a driveline, wherein the controller is configured to command an enhanced charging operation to be performed in which the charging command means is configured to cause the electrical generator to generate charge when a first set of conditions are met, the first set of conditions comprising the conditions that the vehicle is stationary, the user has commanded application of a brake to hold the vehicle stationary and a transmission is in one said one or more predetermined operating conditions.

### INCORPORATION BY REFERENCE

The entire contents of co-pending UK patent application numbers GB1111288.5, GB1211910.3 and GB1202427.9 and UK patents GB2325716, GB2308415, GB2341430, GB2382158 and GB2381597 are expressly incorporated herein by reference. The content of UK patent GB2483371 and US2003/0200016 is hereby incorporated by reference.

### TECHNICAL FIELD

The present invention relates to a controller for a hybrid electric vehicle. In particular but not exclusively, embodiments of the present invention relate to a controller for hybrid electric vehicles which are operable in a parallel mode.

### BACKGROUND

It is known to provide a parallel hybrid electric vehicle having an internal combustion engine and an electrical propulsion motor each operable to provide drive torque to drive the vehicle, alone or in combination. The propulsion motor is powered by a propulsion battery. The vehicle may be operated in an electric vehicle (EV) mode in which the engine is switched off and the electrical propulsion motor provides drive torque to drive the vehicle as required. The vehicle may also be operated in a parallel mode in which the engine is switched on and the electrical propulsion motor is operable either to provide drive torque in addition to the engine, in a parallel boost mode, or to generate electrical charge to recharge the propulsion battery, in a parallel recharge mode. A vehicle control system determines when to switch the internal combustion engine on or off, and when to open or close a clutch KO between the engine and a transmission. In some vehicles the electric propulsion motor is integrated into the transmission.

When driving in off-road conditions, a reduction in state of charge (SOC) of a vehicle propulsion battery may occur relatively quickly, resulting in a drop in vehicle performance, due to relatively high torque demands placed on the engine and electric propulsion motor. If the SOC is relatively high at the start of off-road operations, a user may notice a change in vehicle performance as the SOC depletes and insufficient charge is available for operation of the electrical propulsion motor. It can be difficult to maintain an adequate SOC during off-road operations due at least in part to limited opportunities to effect regenerative braking and frequent operation of the powertrain in the parallel boost mode rather than the parallel recharge mode. In some vehicles, one or more auxiliary electrical systems may be powered by the propulsion battery, particularly relatively large consumers of electrical power such as air-conditioning plant. Accordingly, a user may lose air conditioning functionality in addition to the ability of the electric propulsion motor to provide torque boost to the engine.

It is also known to provide a vehicle having a plurality of subsystems which can be operated in different configurations to suit different driving conditions. For example, automatic transmissions may be controlled in a variety of modes such as sport, manual, winter or economy. In each mode, subsystem control parameters such as accelerator pedal response and conditions under which changes between gear ratios take place may be modified so as to suit the conditions of the terrain or the particular taste of the driver.

It is also known to provide air suspensions with on-road and off-road modes. Stability control systems can be operated at reduced activity in certain modes so as to give the driver more direct control, and power steering systems can be operated in different modes to provide a varying level of assistance depending on driving conditions.

It is desirable to provide an improved control system for a motor vehicle operable in different configurations.

### SUMMARY OF THE INVENTION

Embodiments of the invention may be understood with reference to the appended claims.

Aspects of the present invention provide a control system, a vehicle and a method.

In one aspect of the invention for which protection is sought there is provided a controller for a hybrid electric vehicle comprising:
charging command means for causing an engine-driven electrical generator to generate charge to charge a propulsion charge storage device;
means for determining when a vehicle is stationary;
means for determining when a user has commanded application of a brake to hold a vehicle stationary; and
means for determining when a vehicle is in an off-road environment, wherein the controller is configured to command an enhanced charging operation to be performed in which the charging command means is configured to cause the electrical generator to generate charge when a first set of conditions are met, the first set of conditions comprising the conditions that the vehicle is stationary, the user has commanded application of a brake to hold the vehicle stationary and the vehicle is in an off-road environment.

The first set of conditions may further comprise the condition that a state of charge (SOC) of the propulsion charge storage device is less than a predetermined value.

A controller may be configured to set a speed of an engine to a predetermined speed when an enhanced charging operation is performed.

A controller may be configured to set a speed of an engine to a predetermined speed that is determined in dependence at least in part on a frequency with which enhanced charging operations are being performed.

A controller may be configured to set an engine speed to a predetermined value that is determined in dependence at least in part on a duration of one or more enhanced charging operations, optionally an average duration.

A controller may be configured to cause an increase in engine speed to a speed determined in dependence at least in part on a signal indicative of a driving style of a user.

The driving style may be determined at least in part in dependence on one or more selected from amongst a frequency with which a user demands an amount of drive torque requiring operation of the engine and electrical propulsion motor, a frequency with which a user actuates an accelerator control to demand an amount of drive torque not requiring operation of the electrical propulsion motor, a rate at which a user causes movement of an accelerator control to actuate an accelerator control, and a rate at which a user causes movement of an accelerator control to cause an increase in an amount of demanded drive torque.

A controller may be configured to receive a signal indicative of a driving mode in which a vehicle is operating, wherein a vehicle is determined to be in an off-road environment in dependence on the vehicle operating in one of a predetermined one or more driving modes.

The signal indicative of a driving mode in which a vehicle is operating corresponds to a state of a manual driving mode selector input device or a signal indicative of a driving mode selected automatically by automatic driving mode selection means.

A controller may be configured to receive a signal from one or more sensors, the signal being indicative of a vehicle operating in an off-road environment, wherein a vehicle is determined to be in an off-road environment in dependence on said signal. The signal may be received from a vehicle mounted camera, the signal being indicative of a type of terrain in the vicinity of the vehicle. Alternatively, the signal may be received from a global positioning system (GPS) wherein the signal is indicative of the position of the vehicle. The signal may be received from sensors on vehicle, such as radar system and rain sensor, to show indicative of a type of terrain.

A controller may comprise means for determining when a transmission is in a predetermined one or more operating conditions in which the transmission is configured to deliver drive torque to a driveline, wherein the first set of conditions comprises a transmission being in said one or more predetermined operating conditions.

In a further aspect of the invention for which protection is sought there is provided a motor vehicle control system comprising a controller according to a preceding aspect.

The control system may have a subsystem controller for initiating control of a vehicle subsystem in the selected one of the plurality of subsystem control modes, each one of the driving modes corresponding to one or more different driving conditions for a vehicle wherein the driving modes are control modes of at least one subsystem of a vehicle.

In each subsystem control mode the system may be configured to cause at least one vehicle subsystem to be operated in a subsystem configuration mode appropriate to the driving condition.

The driving modes may be control modes of a plurality of vehicle subsystems. The driving modes may include one or more control modes selected from the following:
control modes of at least one vehicle subsystem selected from amongst an engine management system, a transmission system, a steering system, a brakes system and a suspension system;
control modes of a suspension system and the plurality of subsystem configuration modes comprise a plurality of ride heights;
control modes of a fluid suspension system in which fluid interconnection can be made between suspensions for wheels on opposite sides of the vehicle, and wherein said plurality of subsystem configuration modes provide different levels of said interconnection;
control modes of a steering system which can provide steering assistance, and wherein said plurality of subsystem configuration modes provide different levels of said steering assistance;
control modes of a brakes system which can provide braking assistance, and said plurality of subsystem configuration modes provide different levels of said braking assistance;
control modes of a brake control system which can provide an anti-lock function to control wheel slip, and said plurality of subsystem configuration modes allow different levels of said wheel slip;
control modes of a powertrain system which includes a powertrain control means and an accelerator or throttle pedal, the subsystem configuration modes providing different levels of responsiveness of the powertrain control means to movement of the accelerator or throttle pedal;
control modes of a traction control system which is arranged to control wheel spin, and said plurality of subsystem configuration modes allow different levels of said wheel spin;
control modes of a yaw control system which is arranged to control vehicle yaw, and said plurality of subsystem configuration modes allow different levels of divergence of said vehicle yaw from an expected yaw;
control modes of a range change transmission and said subsystem configuration modes may include a high range mode and a low range mode of said transmission; and
control modes of a transmission system operable in a plurality of transmission ratios and including a transmission control means arranged to monitor at least one parameter of the vehicle and to select the transmission ratios in response, and wherein the subsystem configuration modes include a plurality of transmission configuration modes in which the transmission ratios are selected differently in response to said at least one parameter.

In one aspect of the invention for which protection is sought there is provided a motor vehicle comprising a controller according to an aspect of the invention or a control system according to an aspect of the invention.

In a further aspect of the invention for which protection is sought there is provided a method of controlling a vehicle implemented by means of a control system comprising:
determining when a vehicle is stationary;
determining when a user has commanded application of a brake to hold a vehicle stationary; and
determining when a vehicle is in an off-road environment, the method further comprising commanding an enhanced charging operation to be performed in which an engine-driven electrical generator is caused to generate charge to charge a propulsion charge storage device when a first set of conditions are met, the first set of conditions comprising the conditions that the vehicle is stationary, the user has commanded application of a brake to hold the vehicle stationary and the vehicle is in an off-road environment.

In an aspect of the invention for which protection is sought there is provided a carrier medium carrying computer readable code for controlling a vehicle to carry out the method of an aspect of the invention.

In one aspect of the invention for which protection is sought there is provided a computer program product executable on a processor so as to implement the method of an aspect of the invention.

In a further aspect of the invention for which protection is sought there is provided a computer readable medium loaded with the computer program product of an aspect of the invention.

In one aspect of the invention for which protection is sought there is provided a processor arranged to implement the method of an aspect of the invention, or the computer program product of an aspect of the invention.

In an aspect of the invention for which protection is sought there is provided a computer readable medium carrying computer program code for controlling a vehicle to carry out the method of an aspect of the invention.

In one aspect of the invention for which protection is sought there is provided a controller for a hybrid electric vehicle comprising:
charging command means for causing an engine-driven electrical generator to generate charge to charge a propulsion charge storage device;
means for determining when a vehicle is stationary;
means for determining when a user has commanded application of a brake to hold a vehicle stationary; and
means for determining when a transmission is in a predetermined one or more operating conditions in which the transmission is configured to deliver drive torque to a driveline,
wherein the controller is configured to command an enhanced charging operation to be performed in which the charging command means is configured to cause the electrical generator to generate charge when a first set of conditions are met, the first set of conditions comprising the conditions that the vehicle is stationary, the user has commanded application of a brake to hold the vehicle stationary and a transmission is in one said one or more predetermined operating conditions.

It is to be understood that for the purposes of the present application, a transmission may be considered to be configured to deliver drive torque to a driveline even if the transmission is not delivering drive torque at a given moment in time due to temporary automatic disconnection of the transmission from the driveline or an engine, for example in order to reduce energy dissipation. Thus in the case of a vehicle having a transmission idle control system or the like, temporary disconnection of the transmission from the driveline, or of an engine from the transmission, may be effected when a user holds a vehicle stationary by means of a brake pedal control when the transmission is in a driving mode such as a forward driving mode (such as D) or a reverse driving mode (such as R).

Temporary disconnection may be performed automatically in order to reduce hydraulic fluid losses due to slipping of a clutch, torque converter or other device allowing relative rotation of an input and an output shaft or the like. In some embodiments, as soon as a driver releases the brake pedal control the powertrain resumes a condition in which the engine delivers drive torque to the driveline via the transmission. Other arrangements are also useful.

It is to be understood that the controller or controllers described herein may comprise a control unit or computational device having one or more electronic processors. The system may comprise a single control unit or electronic controller or alternatively different functions of the controller may be embodied in, or hosted in, different control units or controllers. As used herein the term “control unit” will be understood to include both a single control unit or controller and a plurality of control units or controllers collectively operating to provide the stated control functionality. A set of instructions could be provided which, when executed, cause said computational device to implement the control techniques described herein. The set of instructions could be embedded in said one or more electronic processors. Alternatively, the set of instructions could be provided as software to be executed on said computational device. The speed controller may be implemented in software run on one or more processors. One or more other controllers may be implemented in software run on one or more processors, optionally the same one or more processors as the speed controller. Other arrangements may also be useful.

Optionally, the first set of conditions further comprise the condition that the state of charge (SOC) of the propulsion charge storage device is less than a predetermined value.

The controller may be configured to set a speed of an engine to a predetermined speed when an enhanced charging operation is performed.

The controller may be configured to set a speed of an engine to a predetermined speed that is determined in dependence at least in part on a frequency with which enhanced charging operations are being performed.

Thus the controller may monitor a frequency with which enhanced charging operations are being performed, for example the number of times an enhanced charging operation is being performed in a given time period, and set the engine speed at least in part in dependence on this frequency.

The controller may be configured to set an engine speed to a predetermined value that is determined in dependence at least in part on a duration of one or more enhanced charging operations, optionally an average duration.

Thus the controller may monitor a duration of enhanced charging operations and set the engine speed at least in part in dependence on this duration. Advantageously, the controller may monitor frequency and duration of enhanced charging operations and set the engine speed in dependence at least in part on a combination of frequency and duration, for example in dependence at least in part on a total amount of time for which an enhanced charging operation is performed in a given time period.

The controller may be configured to cause an increase in engine speed to a speed determined in dependence at least in part on a signal indicative of a driving style of a user.

The signal may be in the form of a value of a parameter indicative of driving style, for example a parameter having a range of values from a value indicating (say) an economy-oriented, relatively non-aggressive driving style requiring relatively little use of an electrical propulsion motor in addition to an engine in order to meet driver torque demand, to a value indicating a performance-oriented, relatively aggressive driving style in which operation of an electrical propulsion motor in addition to an engine is required more frequently, and/or the propulsion motor is required to generate higher torque values, in order to meet driver torque demand.

Optionally, the driving style may be determined at least in part in dependence on one or more selected from amongst a frequency with which a user demands an amount of drive torque requiring operation of the engine and electrical propulsion motor, a frequency with which a user actuates an accelerator control to demand an amount of drive torque not requiring operation of the electrical propulsion motor, a rate at which a user causes movement of an accelerator control to actuate an accelerator control, and a rate at which a user causes movement of an accelerator control to cause an increase in an amount of demanded drive torque.

Other conditions are also useful. The driving style may be determined at least in part in dependence on a ratio of a frequency with which a user demands an amount of drive torque requiring operation of the engine and electrical propulsion motor and a frequency with which a user actuates an accelerator control to demand an amount of drive torque not requiring operation of the electrical propulsion motor. Other combinations of frequencies may also be useful.

The controller may be configured to receive a signal indicative of a driving mode in which a vehicle is operating, wherein the first set of conditions further comprise the condition that the vehicle is operating in one of a predetermined one or more driving modes.

Optionally, the signal indicative of a driving mode in which a vehicle is operating corresponds to a state of a manual driving mode selector input device or a signal indicative of a driving mode selected automatically by automatic driving mode selection means.

In a further aspect of the invention for which protection is sought there is provided a motor vehicle control system comprising a controller according to a preceding aspect.

Optionally, the driving modes are control modes of at least one subsystem of a vehicle, the control system having a subsystem controller for initiating control of a vehicle subsystem in the selected one of the plurality of subsystem control modes, each one of the driving modes corresponding to one or more different driving conditions for a vehicle.

Optionally, in each subsystem control mode the system is configured to cause at least one vehicle subsystem to be operated in a subsystem configuration mode appropriate to the driving condition.

Optionally, the driving modes are control modes of a plurality of vehicle subsystems.

Further optionally, the driving modes include one or more control modes selected from the following:
control modes of at least one vehicle subsystem selected from amongst an engine management system, a transmission system, a steering system, a brakes system and a suspension system;
control modes of a suspension system and the plurality of subsystem configuration modes comprising a plurality of ride heights;
control modes of a fluid suspension system in which fluid interconnection can be made between suspensions for wheels on opposite sides of the vehicle, and wherein said plurality of subsystem configuration modes provide different levels of said interconnection;
control modes of a steering system which can provide steering assistance, and wherein said plurality of subsystem configuration modes provide different levels of said steering assistance;
control modes of a braking system which can provide braking assistance, and said plurality of subsystem configuration modes provide different levels of said braking assistance;
control modes of a brake control system which can provide an anti-lock function to control wheel slip, and said plurality of subsystem configuration modes allow different levels of said wheel slip;
control modes of a powertrain system which includes a powertrain control means and an accelerator or throttle pedal, the subsystem configuration modes providing different levels of responsiveness of the powertrain control means to movement of the accelerator or throttle pedal;
control modes of a traction control system which is arranged to control wheel spin, and said plurality of subsystem configuration modes allow different levels of said wheel spin control modes of a yaw control system which is arranged to control vehicle yaw, and said plurality of subsystem configuration modes allow different levels of divergence of said vehicle yaw from an expected yaw;
control modes of a range change transmission and said subsystem configuration modes may include a high range mode and a low range mode of said transmission; and
control modes of a transmission system operable in a plurality of transmission ratios and including a transmission control means arranged to monitor at least one parameter of the vehicle and to select the transmission ratios in response, and wherein the subsystem configuration modes include a plurality of transmission configuration modes in which the transmission ratios are selected differently in response to said at least one parameter.

In one aspect of the invention for which protection is sought there is provided a motor vehicle comprising a controller according to an aspect of the invention or a control system according to an aspect of the invention.

In a further aspect of the invention for which protection is sought there is provided a method of controlling a vehicle implemented by means of a control system comprising:
determining when a vehicle is stationary;
determining when a user has commanded application of a brake to hold a vehicle stationary; and
determining when a transmission is in a predetermined one or more operating conditions in which the transmission is configured to deliver drive torque to a driveline,
the method further comprising commanding an enhanced charging operation to be performed in which an engine-driven electrical generator is caused to generate charge to charge a propulsion charge storage device when a first set of conditions are met, the first set of conditions comprising the conditions that the vehicle is stationary, the user has commanded application of a brake to hold the vehicle stationary and a transmission is one said one or more predetermined operating conditions.

In an aspect of the invention for which protection is sought there is provided a carrier medium carrying computer readable code for controlling a vehicle to carry out the method of an aspect of the invention.

In one aspect of the invention for which protection is sought there is provided a computer program product executable on a processor so as to implement the method of an aspect of the invention.

In a further aspect of the invention for which protection is sought there is provided a computer readable medium loaded with the computer program product of an aspect of the invention.

In one aspect of the invention for which protection is sought there is provided a processor arranged to implement the method of an aspect of the invention, or the computer program product of an aspect of the invention.

In an aspect of the invention for which protection is sought there is provided a computer readable medium carrying computer program code for controlling a vehicle to carry out the method of an aspect of the invention.

In one aspect of the invention for which protection is sought there is provided a controller for a hybrid electric vehicle configured to:
cause an engine-driven electrical generator to generate charge to charge a propulsion charge storage device;
determine when a vehicle is stationary;
determine when a user has commanded application of a brake to hold a vehicle stationary; and
determine when a vehicle is in an off-road environment,
wherein the controller is configured to command an enhanced charging operation to be performed in which the controller is configured to cause the electrical generator to generate charge when a first set of conditions are met, the first set of conditions comprising the conditions that the vehicle is stationary, the user has commanded application of a brake to hold the vehicle stationary and the vehicle is in an off-road environment.

In one embodiment of the invention for which protection is sought, a hybrid electric vehicle is provided with a control system operable automatically to cause the vehicle to undertake an enhanced battery charging operation when the vehicle is operated in a parallel hybrid driving mode, and the conditions are met that the (a) the vehicle is being held stationary by means of a brake of the vehicle, (b) the transmission in the reverse (R) or drive (D) operating modes and (c) a driver is depressing a brake pedal. The embodiment permits the vehicle to recharge a charge storage device thereof such as a battery more quickly than would otherwise be the case if the vehicle were held stationary with the transmission in the reverse or drive operating modes.

For purposes of this disclosure, it is to be understood that the controller described herein can comprise a control unit or computational device having one or more electronic processors.

A vehicle and/or a system thereof may comprise a single control unit or electronic controller or alternatively different functions of the control module may be embodied in, or hosted in, different control units or controllers.

As used herein, the term “controller” will be understood to include both a single control unit or controller and a plurality of control units or controllers collectively operating to provide the required control functionality.

A set of instructions could be provided which, when executed, cause said controller(s) or control unit(s) to implement the control techniques described herein (including the method(s) described below). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on or more electronic processors, optionally the same one or more processors as the first controller. It will be appreciated, however, that other arrangements are also useful, and therefore, the present invention is not intended to be limited to any particular arrangement. In any event, the set of instructions described above may be embedded in a computer-readable storage medium (e.g., a non-transitory storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM ad EEPROM); flash memory; or electrical or other types of medium for storing such information/instructions.

Within the scope of this application it is envisaged that the various aspects, embodiments, examples, features and alternatives set out in the preceding paragraphs, in the claims and/or in the following description and drawings may be taken independently or in any combination. Features described with reference to one embodiment are applicable to all embodiments, unless there is incompatibility of features.

For the avoidance of doubt, it is to be understood that features described with respect to one aspect of the invention may be included within any other aspect of the invention, alone or in appropriate combination with one or more other features.

### BRIEF DESCRIPTION OF THE DRAWINGS

Embodiments of the invention will now be described with reference to the accompanying figures in which:

FIG. 1 is a schematic illustration of a hybrid electric vehicle according to an embodiment of the present invention;

FIG. 2 is a schematic illustration of a controller according to an embodiment of the present invention; and

FIG. 3 is a flow diagram illustrating a method according to an embodiment of the present invention.

### DETAILED DESCRIPTION

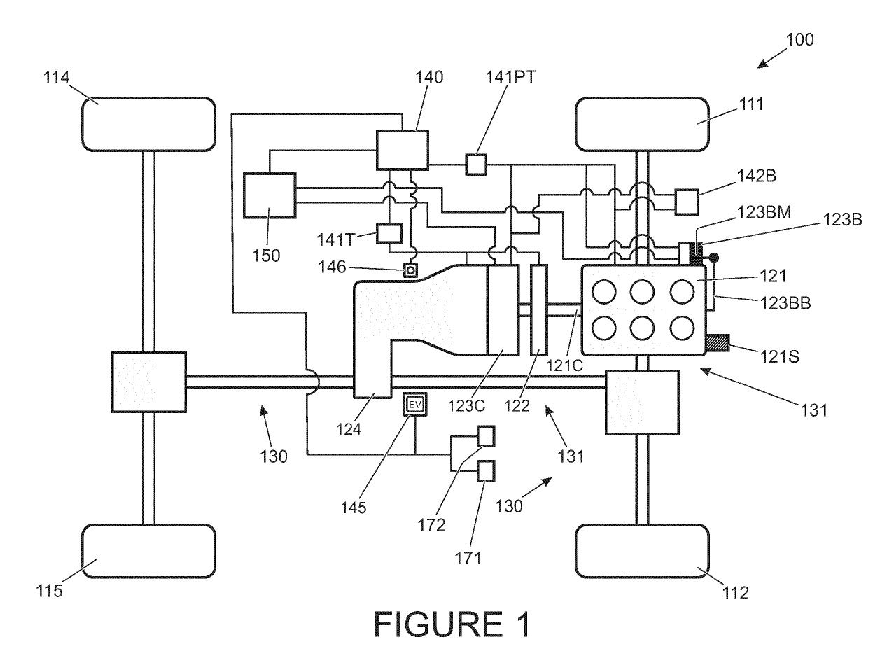

In one embodiment of the invention a hybrid electric vehicle 100 is provided as shown in FIG. 1. The vehicle 100 has an engine 121 coupled to a belt integrated starter generator (BISG) 123B. The BISG 123B may also be referred to as a belt integrated (or belt mounted) motor generator and is operable to crank the engine 121 when starting is required. In addition or instead, a dedicated starter motor 121S may be provided. In some embodiments therefore, a BISG may be provided but a separate starter motor is employed for starting the engine 121. In some embodiments the BISG is omitted, and the starter motor 121S is employed to start the engine 121.

The engine 121 is coupled in turn to a crankshaft-integrated starter/generator (CIMG) 123C by means of a crankshaft 121C and clutch 122. The clutch 122 may also be referred to as a KO clutch 122. The CIMG 123C is also operable to crank the engine 121 when required.

The CIMG 123C is integrated into a housing of a transmission 124 which is in turn coupled to a driveline 130 of the vehicle 100 thereby to drive a pair of front wheels 111, 112 and a pair of rear wheels 114, 115 of the vehicle 100. The driveline 130 in combination with the transmission 124, CIMG 123C, clutch 122, engine 121 and BISG 123B may be considered to form part of a powertrain 131 of the vehicle 100. Wheels 111, 112, 114, 115 arranged to be driven by the driveline 130 may also be considered to form part of the powertrain 131. The transmission is controlled by means of a transmission controller 141T.

It is to be understood that other arrangements are also useful. For example the driveline 130 may be arranged to drive the pair of front wheels 111, 112 only or the pair of rear wheels 114, 115 only, or to be switchable between a two wheel drive mode in which the front or rear wheels only are driven and a four wheel drive mode in which the front and rear wheels are driven.

The BISG 123B and CIMG 123C are arranged to be electrically coupled to a charge storage module 150 (which may also be referred to as an energy storage module 150) having a battery and an inverter. The module 150 is operable to supply the BISG 123B and/or CIMG 123C with electrical power when one or both are operated as propulsion motors. Similarly, the module 150 may receive and store electrical power generated by the BISG 123B and/or CIMG 123C when one or both are operated as electrical generators. In some embodiments, the CIMG 123C and BISG 123B may be configured to generate different electrical potentials to one another. Accordingly, in some embodiments each is connected to a respective inverter adapted to operate at the corresponding potential of the CIMG 123C or BISG 123B. Each inverter may have a respective battery associated therewith. In some alternative embodiments the CIMG 123C and BISG 123B may be coupled to a single inverter which is adapted to receive charge from the CIMG 123C and BISG 123B at the respective potentials and to store the charge in a single battery. Other arrangements are also useful.

As noted above, the BISG 123B has an electric machine 123BM that is drivably coupled to the crankshaft 121C of the engine 121 by means of a belt 123BB. The BISG 123B is operable to provide torque to the crankshaft 121C when it is required to start the engine 121 or when it is required to provide torque-assist to the driveline 130.

The vehicle 100 has a vehicle controller 140 operable to command a powertrain controller 141PT to control the engine 121 to switch on or off and to generate a required amount of torque. The vehicle controller 140 is also operable to command the powertrain controller 141PT to control the BISG 123B to apply a required value of positive or negative torque (operating as a propulsion motor or a generator) to the engine 121. Similarly, the vehicle controller 140 may command the CIMG 123C to apply a required value of positive or negative torque (again operating as a propulsion motor or a generator) to the driveline 130 via the transmission 124.

The vehicle has an accelerator pedal 171 and a brake pedal 172. The accelerator pedal 171 provides an output signal to the vehicle controller 140 indicative of an amount by which the pedal 171 is depressed. The vehicle controller 140 is arranged to determine the amount of driver demanded torque based on the accelerator pedal position and one or more other vehicle parameters including engine speed W. In some embodiments, the powertrain controller 141PT is arranged to receive the accelerator pedal position signal and calculate the amount of driver demanded torque.

The vehicle 100 of FIG. 1 is operable by the vehicle controller 140 in an electric vehicle (EV) mode in which the clutch 122 is open and the crankshaft 121C is stationary. In EV mode the CIMG 123C is operable to apply positive or negative torque to the driveline 130 via the transmission 124. Negative torque may be applied for example when regenerative braking is required under the control of a brake controller 142B.

The powertrain 131 is operable in one of a plurality of parallel modes in which the engine 121 is switched on and the clutch 122 is closed. The parallel modes include a ‘parallel boost’ mode in which the CIMG 123C is operated as a motor to provide drive torque to the driveline 130 in addition to the torque provided by the engine 121. In the present embodiment the powertrain 131 is operated in the parallel boost configuration when the amount of driver demanded torque exceeds the maximum torque available from the engine 121. The amount of additional torque available from the CIMG 123C may be determined in dependence on the vehicle configuration as described in more detail below. It is to be understood that the feature of torque boost increases the available drive torque beyond that which is available from the engine 121 alone.

The parallel modes also include a parallel torque filling mode and a parallel torque assist mode. The parallel torque filling mode is a mode in which the CIMG 123C delivers drive torque to the driveline 130 in addition to the engine 121 in order to meet driver demand for torque more quickly than if the engine 121 alone delivers drive torque. Torque filling provides the benefit that driver torque demand may be satisfied more quickly, improving a responsiveness of the vehicle to an increase in torque demand, since the CIMG 123C is typically able to respond more quickly to torque requests than the engine 121.

In the present embodiment torque filling is implemented when a rate of increase of driver torque demand relative to the amount of torque delivered by the engine 121 exceeds a prescribed value. Once driver torque demand has been satisfied, the amount of torque delivered by the CIMG 123C decreases as the amount of torque delivered by the engine 121 increases to meet driver demand substantially entirely, without a requirement for additional torque from the CIMG 123C.

In the torque-assist parallel mode the CIMG 123C provides steady-state drive torque in addition to the engine 121 in order to relieve loading on the engine 121. This may assist in reducing fuel consumption. Torque-assist may be considered to be distinct from ‘torque filling’, the latter being employed in a transient manner when an increase in drive torque is required.

The powertrain 131 may alternatively be operated in a parallel recharge mode in which the CIMG 123C is driven as a generator by the engine 121 to recharge the charge storage module 150.

The vehicle 100 has a hybrid mode selector control 145 in the form of a rotatable dial. The selector control 145 is operable to select one of three hybrid modes: an EV mode, a hybrid mode and a hybrid inhibit mode.

In the EV mode, the controller 140 causes the engine 121 to remain switched off whilst propulsion torque is delivered, as required, by means of the CIMG 123C only. Once the state of charge of the charge storage module 150 falls below a predetermined amount, for example below 10% of a maximum usable charge capacity, the controller 140 causes the engine 121 to be switched back on and the powertrain 131 to assume the parallel recharge mode until the state of charge exceeds a predetermined value, for example 25% of a maximum usable charge capacity.

In the hybrid mode, the controller 140 causes the powertrain 131 to assume a parallel mode or the EV mode in dependence on an energy management methodology implemented by the controller 140. Further details of the energy management methodology may be found in GB2483371. The controller 140 seeks to balance the use of charge stored in the charge storage module 150 to operate the CIMG 123C as a propulsion motor and the burning of fuel by the engine 121 in order to reduce emission of greenhouse gases such as carbon dioxide. Other energy management methodologies are also useful.

In the hybrid inhibit mode, the controller 140 latches the engine 121 in the on condition and the KO clutch 122 in the closed condition and causes the engine 121 to drive the transmission 124 substantially continually whilst the transmission 124 is in a driving mode in which drive torque may be delivered by the transmission 124 to the road wheels 111, 112, 114, 115.

The brake controller 142B is operable to cause a friction-based foundation braking system to cause braking of each of the road wheels 111, 112, 114, 115. The brake controller 142B is also operable to command the powertrain controller 141PT to cause the CIMG 123C to act as a generator and apply negative torque to the driveline 130 in order to cause braking. This may be referred to as regenerative braking since charge generated by the CIMG 123C in effecting braking may be stored in the charge storage module 150.

The vehicle 100 is also operable by the controller 140 in a selected one of a plurality of driving modes or control modes. In the present embodiment the driving modes are user-selected by means of a driving mode selector dial 146. In each driving mode each one of a plurality of vehicle subsystems are operated in a subsystem configuration mode appropriate to a given driving condition. The driving modes typically include a grass/gravel/snow control mode (GGS mode) that is suitable for when the vehicle is travelling in grass, gravel or snow terrain, a mud/ruts control mode (MR mode) which is suitable for when the vehicle is travelling in mud and ruts terrain, a rock crawl/boulder mode (RC mode) which is suitable for when the vehicle is travelling in rock or boulder terrain, a sand mode which is suitable for when the vehicle is travelling in sand terrain (or deep soft snow) and a special programs OFF mode (SP OFF mode or SPO mode) which is a suitable compromise mode, or general mode, for all terrain conditions and especially vehicle travel on motorways and regular roadways. The SPO mode may also be referred to as a highway mode. Many other control modes are also envisaged including those disclosed in US2003/0200016.

The different terrain types are grouped according to the friction of the terrain and the roughness of the terrain. For example, it is appropriate to group grass, gravel and snow together as terrains that provide a low friction, smooth surface and it is appropriate to group rock and boulder terrains together as high friction, very high roughness terrains. The driving modes may be referred to as ‘terrain response’ or ‘TR’ (RTM) modes.

The controller 140 commands vehicle subsystem controllers to assume a predetermined subsystem control mode in dependence on the selected driving mode. In the present embodiment the controller 140 commands the transmission controller 141T, powertrain controller 141PT and brake controller 142B to assume a predetermined subsystem control mode. In some embodiments other vehicle subsystems may have subsystem configuration modes commanded by the controller 140 such as a power steering control system (not shown), suspension control system such as an air suspension control system (not shown) and/or any other suitable subsystem.

The brake controller 142B may be arranged to provide relatively high brake force for a given amount of pressure applied to the brake pedal 172 or a relatively low brake force, depending on the driving mode. The brake controller 142B may also be arranged to allow different levels of wheel slip when an anti-lock braking system is active, for example relatively low amounts on low friction (“low-mu”) surfaces and relatively large amounts on high friction (“high-mu”) surfaces.

The powertrain controller 141PT may be operated in ‘quick’ or ‘slow’ accelerator (or throttle) pedal progression configuration modes in which an increase in engine torque as a function of accelerator pedal progression is relatively quick or slow, respectively. The rate may be dependent on speed in one or more modes such as Sand mode.

The transmission controller 141T may be operated in a “normal” mode that provides a reasonable compromise between fuel economy and driving performance, a “performance” mode which generally keeps the transmission in lower gears than in the normal mode, particularly when the driver is requesting a high level of driving torque to accelerate the vehicle, and a “manual” mode in which the control of gear changes is given completely to the driver. The transmission 124 also has a “snow” or “ice” mode which generally keeps the transmission 124 in higher gears than the normal mode, in particular under acceleration from rest, to avoid loss of traction due to wheel spin, and a “sand” mode which keeps the transmission in relatively high gears at low speed to avoid excessive wheel spin. Excessive wheel spin can result in the wheels digging themselves into the sand at low speeds. However, the sand mode uses relatively low gears at higher speeds where a relatively high degree of wheel slip can be desirable to provide maximum traction. Lower gearing also helps the engine 121 to remain in an operating region where the engine speed is high and the power output is high, thereby helping to avoid the vehicle 100 becoming “bogged down” by a lack of power.

The vehicle 100 has an electrically powered climate control system (not shown) that is arranged to draw electrical power from the charge storage module 150 when required. The climate control system represents a non-essential auxiliary electrical load. By non-essential is meant that the vehicle 100 is still capable of driving whether or not the climate control system is operational. One or more other non-essential auxiliary electrical systems may also be present. It is to be understood that the vehicle 100 also has ‘essential’ electrical loads which are always provided with electrical power. The essential loads include loads for powering an HMI system and external lighting loads such as headlamps, brake lights and the like. In some embodiments, the essential loads may be denied power only if the provision of power to the essential loads would otherwise cause the engine 121 to stall.

In the present embodiment the controller 140 is configured to perform an enhanced charging operation when the vehicle is operating in off-road conditions. The controller 140 determines that the vehicle 100 is operating in off-road conditions if the user has selected a driving mode other than the SPO (highway) driving mode. In the present embodiment the controller 140 is also operable in an automatic driving mode selection condition in which the controller 140 determines automatically the most appropriate driving mode (or ‘TR mode’) for the prevailing conditions, in addition to a manual driving mode selection condition in which the controller 140 causes the vehicle 100 to operate in the driving mode selected manually by a user by means of the selector dial 146. It is to be understood that the automatic driving mode selection condition is selected by a user by means of the selector dial 146. In some alternative embodiments an automatic driving mode selection condition is not available.

In some embodiments the controller 140 may be configured to perform the enhanced charging operation whenever the vehicle 100 is operated in the SPO or highway driving mode regardless of whether the controller 140 is operating in the automatic mode selection condition or manual mode selection condition. In some alternative embodiments, including the present embodiment, the controller performs the enhanced charging operation only when the controller 140 is not operating in the automatic driving mode selection condition and the user has selected a driving mode other than the highway driving mode.

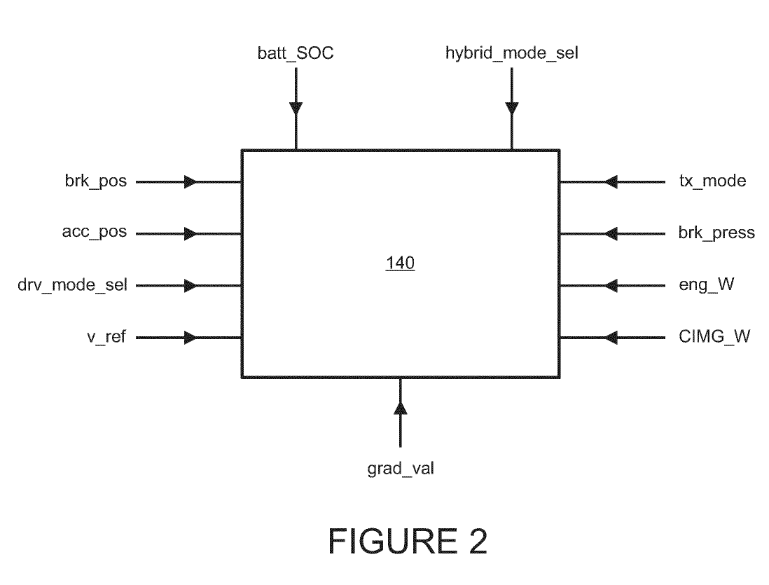

FIG. 2 is a schematic illustration of the controller 140 showing some of the signals input to the controller 140 from devices external to the controller 140. The signals include a vehicle reference speed signal v_ref indicative of the instant speed of the vehicle over ground, a signal drv_mode_sel generated by selector dial 146 indicative of the driving mode selected by a user and whether a user has selected the automatic driving mode selection condition, a signal acc_pos indicative of a position of accelerator pedal 171 with respect to a range of travel of the pedal 171, a signal brk_pos indicative of a position of brake pedal 172 with respect to a range of travel of the pedal 172, a signal batt_SOC indicative of a state of charge (SOC) of the charge storage module 150, a signal hybrid_mode_sel indicative of the hybrid mode selected by a user by means of hybrid mode selector control 145, a signal tx_mode indicative of a selected operating mode of the transmission, a signal brk_press indicative of a pressure of hydraulic brake fluid in a braking system corresponding to the pressure causing brake force to be applied to each wheel 111, 112, 114, 115, a signal eng_W indicative of a speed of rotation of the engine 121, a signal CIMG_W indicative of a speed of rotation of the CIMG 123C and a signal grad_val indicative of a gradient of the driving surface. The signal grad_val is arranged to have a positive value if the vehicle is facing uphill on an inclined driving surface, a negative value if the vehicle 100 is facing downhill on an inclined driving surface, and a value of substantially zero if the vehicle is situated on a substantially level (horizontal) driving surface. The signal grad_val may be generated by one or more accelerometer devices in some embodiments.

The signal tx_mode indicates which of four operating modes the transmission 124 is currently set to operate in, selected from the available modes P (park mode), R (reverse driving mode), N (neutral mode) and D (forward driving mode).

The controller 140 is configured to cause the vehicle 100 to operate in the driving mode selected by the user by means of the selector 146. In some embodiments, the controller 140 is configured not to assume one or more driving modes other than the highway driving mode even if selected by a user unless one or more predetermined conditions are met. For example, in a vehicle having a suspension system operable in a plurality of subsystem configuration modes in each of which the suspension is operated at a different ride height, certain driving modes (such as the RC driving mode) may be allowable only if the suspension is set to a predetermined ride height such as a ‘high’ ride height, in order to permit adequate obstacle clearance.

The controller 140 generates an internal signal drv_mode_sel_actual corresponding to the actual driving mode in which the controller 140 causes the vehicle 100 to operate. Similarly, the controller 140 generates an internal signal hybrid_mode_sel_actual corresponding to the actual hybrid mode in which the controller 140 causes the powertrain 131 to operate. When the vehicle 100 is in a driving mode other than the highway mode the controller causes the powertrain 131 to operate in the hybrid inhibit driving mode regardless of the state of the hybrid mode selector control 145. Accordingly, if the signal drv_mode_sel_actual corresponds to a driving mode other than the highway driving mode, the controller 140 causes the powertrain 131 to operate in the hybrid inhibit mode.

When the controller 140 is operating in the manual driving mode selection condition and a driving mode other than the highway driving mode has been selected, the controller 140 monitors the signals tx_mode, v_ref and brk_pos. If the signal tx_mode indicates that the transmission 124 is in the forward driving mode D, the signal v_ref indicates that the vehicle 100 is substantially stationary and the signal brk_pos indicates that the driver is currently pressing the brake pedal 172, the controller 140 checks the value of signals grad_val and brk_press. The controller 140 then performs a calculation as to the amount of powertrain torque, PT_TQ_crit, required to cause the vehicle 100 to overcome the brake force imposed on the vehicle 100 by the braking system under the control of the brake controller 142B. The signal brk_press is employed by the controller 140 to determine the brake force on the vehicle, and the signal grad_val is employed in order to take into account the effects of gravity on the vehicle 100. Thus, it is to be understood that in the case that the vehicle 100 is facing uphill on an inclined driving surface, a larger value of powertrain torque PT_TQ would be required to cause the vehicle 100 to move uphill, than would be required to cause the vehicle 100 to move downhill if the vehicle 100 were facing downhill, for a given driving surface, vehicle weight and weight distribution.

Having determined a value of PT_TQ_crit, the controller 140 causes the powertrain 131 to assume the parallel recharge mode if it is not already in that mode, and controls the powertrain 131 to develop an amount of torque substantially equal to 80% of the value of PT_TQ_crit, i.e. substantially 0.8 PT_TQ_crit. The CIMG 124C is caused to apply a negative torque to the powertrain 131 of magnitude CIMG_TQ, reducing the net value of the torque developed by the powertrain 131, PT_TQ net, to a value (0.8PT_TQ_crit−CIMG_TQ). The value of CIMG_TQ is selected to be a value that is sufficiently low not to cause stalling of the engine 121. In some embodiments, the value of CIMG_TQ is selected such that the net value of PT_TQ net is not less than a predetermined value, optionally 100 Nm or any other suitable value.

It is to be understood that, by limiting the amount of torque developed by the powertrain, PT_TQ, to a value 0.8 PT_TQ_crit, unexpected movement of the vehicle 100 in the event the CIMG 123C ceases application of torque to the powertrain 131 unexpectedly may be prevented, for example in the case of a fault.

In the present embodiment, the transmission 124 is configured to accommodate turning of the CIMG 123C whilst the vehicle 100 is stationary and the transmission 124 is in the forward driving mode by slipping of one or more clutch devices of the transmission 124.

In some embodiments the controller 140 is configured to cause the transmission controller 141T to disconnect the transmission 124 from the CIMG 123C or driveline 130 when an enhanced charging operation is performed, rather than allowing the transmission 123 to accommodate rotation of the CIMG 123C by slipping of one or more clutches. This has the advantage that an amount of energy dissipated by the transmission 124 when an enhanced charging operation is performed may be reduced.

In some embodiments the controller 140 or another associated controller may be configured to implement a brake release control methodology such as a gradient release control function, GRC (RTM) in which the brake controller 142B is configured automatically to reduce the amount of brake force applied by a braking system to substantially zero in a gradual manner when the vehicle is on a driving surface having a gradient exceeding a predetermined amount and the engine speed eng_W exceeds a predetermined value. When an enhanced charging operation is not in progress, the controller 140 is configured to trigger the GRC function when the function has been selected by a user, the transmission 124 is in the forward or reverse driving mode and the engine speed eng_W exceeds the predetermined value. When an enhanced charging operation is in progress, in the present embodiment the controller 140 suspends the GRC function whilst the brake pedal 172 is depressed, but allows the GRC function to be triggered once a driver releases the brake pedal 172 and the required conditions for triggering the GRC function are met.

In some embodiments, the controller 140 is configured to cause a speed of the engine 121 to fall to idle speed in the event the driver releases the brake pedal 172 within a predetermined period of time following the moment at which the brake pedal 172 reaches a position corresponding to substantially zero travel.

The predetermined period may be any suitable period such as 0.1 s, 0.2 s, 0.5 s or any other suitable period. The predetermined period may be substantially equal to an average amount of time required for a user to commence depression of the accelerator pedal 171 after releasing the brake pedal 172. In the present embodiment the controller 140 is configured to achieve engine speed reduction within the predetermined period at least in part by reducing an amount of fuel and/or air supplied to the engine 121 in the normal manner, and in addition controlling the amount of negative torque applied by the CIMG 123C to the engine 121, so as to reduce engine speed more quickly, if required.

The speed to which the engine speed is required to fall within the predetermined period of release of the brake pedal 172, eng_W_tgt, may be dependent on the value of grad_val in some embodiments. The value of eng_W_tgt may increase with increasingly positive values of grad_val and decrease for increasingly negative values of grad_val.

In some embodiments, the controller 140 may be configured to reduce engine torque at a rate substantially equal to or greater than that at which the driver reduces brake pressure as the driver releases the brake pedal 172. The selected rate at which engine torque is reduced may be dependent at least in part on factors such as angle of inclination of the vehicle 100 and intended direction of travel. For example, if the vehicle 100 is facing uphill with the transmission in a forward gear such as transmission operating mode D′. the controller 140 may cause the engine torque value to reduce at a lower rate than if the vehicle were facing downhill in transmission operating mode D′. This is at least in part because when facing uphill the increased engine idle torque developed whilst an enhanced charging operation is in progress is less likely to cause the vehicle 100 to suddenly move forward if slip of one or more clutches associated with the transmission 124 were to cease and the increased idle torque were to be transmitted to the driveline 130.

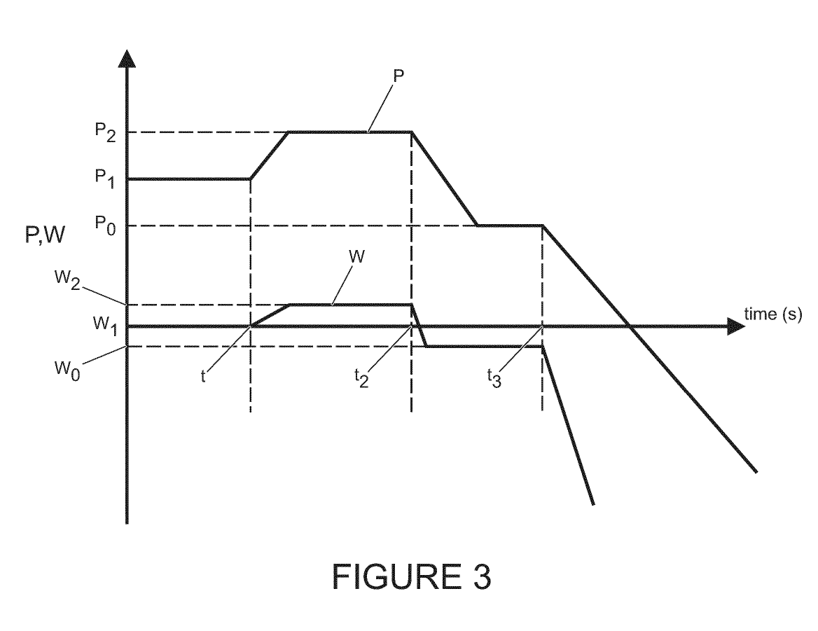

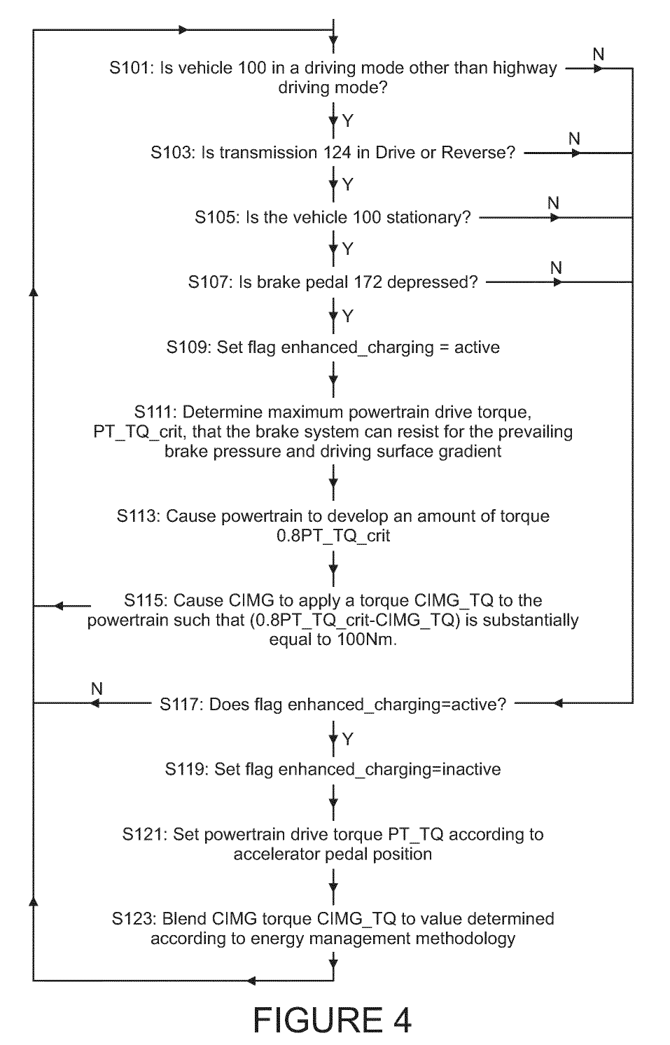

FIG. 3 illustrates an example of driver-induced variation in brake pressure P during an enhanced charging operation, with corresponding variation in engine speed W.

It can be seen that an increase in brake pressure from P1 to P2 at time t1 permits an increase in engine speed from W1 to W2. When brake pressure is subsequently decreased at time t2 from P2 to P0, engine speed W is decreased from value W2 to W0 at a higher rate than the rate of decrease in brake pressure. The controller 140 continually monitors brake pressure and ensures that engine speed decreases at a greater rate, optionally by adjusting the timing of fuel injection and/or air flow rate into the engine 121 in order to reduce engine speed in a similar manner to that implemented in some known traction control systems.

Similarly, when a further decrease in brake pressure begins at time t3, the controller 140 ensures that engine speed W decreases at a faster rate than the rate of decrease in brake pressure P.

In some embodiments, the amount of torque applied by the CIMG 123C to the engine 121 in order to effect charging of the charge storage module 150, CIMG_TQ, may be determined at least in part in dependence on the frequency of stops made by a driver where the driver holds the vehicle 100 stationary using the brake pedal 172 with the transmission 124 in the forward driving mode D. In some embodiments the value of CIMG_TQ may be arranged to decrease with increasing frequency of stops since the CIMG 123C may perform an enhanced charging operation more often. In some embodiments the value of CIMG_TQ may be determined in further dependence on a measure of the amount of time for which an enhanced charging operation is performed in a given time period.

By way of illustration of the operation of the controller 140, a first driver may make on average only two stops every 300 s (5 minutes) but the stops may be on average 45 s long, totaling 90s of stationary time available for an enhanced charging operation per 300 s. A second driver may make on average 5 stops every 300 s which are on average only 10 s long, totaling 50s of stationary time available for an enhanced charging operation per 300 s. In the case of the first driver, the controller 140 may employ a lower value of CIMG_TQ during the enhanced charging operation than in the case of the second driver.

However the controller 140 is configured also to take into account the SOC of the charge storage module 150. If the SOC is relatively low the controller 140 may employ the greatest allowable value of CIMG_TQ for the prevailing conditions, when an opportunity to undertake an enhanced charging operation arises.

In some embodiments the controller 140 may also take into account a driving style of a driver. Thus if a driver tends to demand relatively large amounts of powertrain torque PT_TQ whilst driving, requiring the CIMG 123C to provide drive torque in addition to that provided by the engine 121 in order to meet driver demand (when the powertrain 131 is operated in the parallel mode in the parallel torque filling mode or the parallel torque assist mode), the controller 140 may increase the value of CIMG_TQ during each enhanced charging operation in order to attempt to ensure that the SOC of the charge storage module 150 remains sufficient to meet driver torque demand.

It is to be understood that in order to accommodate a given value of CIMG_TQ without stalling, the controller 140 and/or powertrain controller 140PT may set a higher value of engine speed eng_W. In some embodiments, the controller 140 and/or powertrain controller 140PT may set the value of eng_W in dependence on the SOC of the charge storage module 150 as well as setting the value of CIMG_TQ in dependence on the SOC of the charge storage module 150, so as to generate a given charging rate of the charge storage module 150.

It is to be understood that, in some embodiments, the controller 140 may take into account an expected amount of NVH arising from an enhanced charging operation at a given moment in time. For example, the controller 140 may determine the required value of CIMG_TQ taking into account the amount of NVH that is likely to be generated as a consequence. For example, in circumstances where a driver demonstrates a performance-oriented driving style in which relatively large amounts of powertrain torque are demanded relatively frequently, as opposed to an economy-oriented driving style in which relatively modest amounts of powertrain torque are demanded, the controller 140 may permit larger values of CIMG_TQ to be commanded during an enhanced charging operation compared with the economy-oriented driving style.

Some embodiments of the present invention have the advantage that a hybrid electric vehicle may be controlled in such a manner as to have a sufficiently high SOC of the charge storage module 150 during off-road operations. This may facilitate more consistent vehicle performance since a drop in vehicle performance may result if an adequate SOC of the charge storage module 150 is not maintained. In some known vehicles, in order to effect charging of the charge storage module 150 the transmission must be placed in the park mode P and an increase in engine speed and engine torque achieved by depression of the accelerator pedal 171 by a user. The user is required to estimate an appropriate amount by which the accelerator pedal 171 should be depressed and to hold the pedal 171 in that position whilst the charge storage module 150 is recharged. This can result in sub-optimum use of available fuel and excessive noise, vibration and/or harshness (NVH) during forced charging.

FIG. 4 illustrates a method of operation of the vehicle 100 of FIG. 1.

At step S101 the controller 140 checks whether the vehicle 100 is in a driving mode other than the highway (SPO) mode. If at the S101 the vehicle 100 is in the highway mode the method continues at step S117 else the method continues at step S103.

At step S103 the controller 140 checks whether a transmission 124 of the vehicle 100 is in the Drive or Reverse operating modes. If the transmission 124 is in one of these modes the method continues at step S105 else the method continues at step S117.

At step S105 the controller 140 checks whether the vehicle 100 is substantially stationary, in the present embodiment whether a speed of each wheel of the vehicle 100 is less than 2 kph although in some embodiments the controller 140 checks whether each wheel is absolutely stationary. If each wheel is found to be substantially stationary the method continues at step S107 else the method continues at step S117.

At step S107 the controller 140 checks whether brake pedal 172 of the vehicle 100 is depressed. If at step S107 the controller 140 determines that the brake pedal 172 is depressed the method continues at step S109 else the method continues at step S117.

At step S109 the controller 140 sets a flag enhanced charging=active. The method then continues at step S111.

At step S111 the controller 140 determines the maximum amount of powertrain drive torque, PT_TQ_crit, that the brake system 22 can resist for the prevailing brake pressure and driving surface gradient. The method then continues at step S113.

At step S113 the controller 140 commences causing the powertrain 129 to develop an amount of torque 0.8 PT_TQ_crit. Substantially simultaneously, at step S115 the controller 140 causes the CIMG to apply a torque CIMG_TQ to the powertrain 129 such that the amount (0.8 PT_TQ_crit−CIMG_TQ) is substantially equal to 100 Nm. The method then continues at step S101.

As noted above, the method may continue at step S117 from any one of steps S101 to S107 in dependence on the outcome of the determination made at each of those steps.

At step S117 the controller 140 determines whether flag enhanced charging=active. If this condition is met, the method continues at step S119 else the method continues at step S101.

At step S119 the controller 140 sets flag enhanced charging=inactive and continues at step S121.

At step S121 the controller 140 causes powertrain drive torque PT_TQ to be determined according to accelerator pedal in the normal manner associated with operation of the vehicle 100 when an enhanced charging operation is not being performed. That is, the amount of torque developed by the powertrain is determined according to accelerator pedal position, and not automatically by the controller 140 as when an enhanced charging operation is being performed. The method then continues at step S123.

At step S123 the controller 140 causes the amount of torque generated by the CIMG 123C, CIMG_TQ, to be adjusted to a value determined according to the energy management methodology implemented by the controller 140, and sets the amount of torque generated by the engine 121 in a similar manner so as to meet driver torque demand. The instant amount of torque developed by the CIMG 123C, CIMG_TQ, is blended with the amount determined according to the energy management methodology over time, from the amount developed when the enhanced charging operation is terminated, to the amount required for the prevailing accelerator pedal position.

In some embodiments, the controller 140 is configured to perform an enhanced charging operation when the vehicle is determined to be operating in off-road conditions. In this case, when the vehicle has been determined to be in an off-road environment, the enhanced charging operation may be performed when the vehicle is stationary, irrespective of the operating mode of the transmission, i.e. the transmission 124 may be selected to operate in P (park mode), R (reverse driving mode), N (neutral mode) or D (forward driving mode). For example, when a transfer case of a vehicle is changing between high and low ranges (which may be indicative of the vehicle operating in an off-road environment), the transmission 124 must select N (neutral mode) to allow the speed of the input shaft to the transfer case to decrease sufficiently before the transfer case shifts between said high and low ranges. During this operation the transmission is disconnected from the CIMG 123C and therefore, the engine is able to drive the CIMG 123C independently from the transmission to generate electricity to charge the traction battery. Thus, embodiments of the invention can take advantage of this opportunity to charge when the transmission 124 selects N (neutral mode). In such embodiments the CIMG 123C can be disconnected from the transmission drive using existing internal transmission clutches or any suitable clutch between the CIMG and transmission input. In an alternative embodiment, the transfer case can be in neutral mode and disconnected from the CIMG 123C.

In another embodiment, the enhanced charging operation can occur when the vehicle is stationary whilst the hill descent/hill climb assist functionality (which may be indicative of the vehicle operating in an off-road environment) is active.

In one embodiment, the enhanced charging operation can occur when the vehicle is stationary whilst trailer towing functionality is active.

Embodiments of the present invention may be understood by reference to the following numbered clauses:

1. A controller for a hybrid electric vehicle configured to:
cause an engine-driven electrical generator to generate charge to charge a propulsion charge storage device;
determine when a vehicle is stationary;
determine when a user has commanded application of a brake to hold a vehicle stationary; and
determine when a transmission is in a predetermined one or more operating conditions in which the transmission is configured to deliver drive torque to a driveline,
wherein the controller is configured to command an enhanced charging operation to be performed in which the controller is configured to cause the electrical generator to generate charge when a first set of conditions are met, the first set of conditions comprising the conditions that the vehicle is stationary, the user has commanded application of a brake to hold the vehicle stationary and a transmission is in one said one or more predetermined operating conditions.
   2. A controller according to clause 1 wherein the first set of conditions further comprise the condition that the state of charge (SOC) of the propulsion charge storage device is less than a predetermined value.
   3. A controller according to clause 1 or clause 2 configured to set a speed of an engine to a predetermined speed when an enhanced charging operation is performed.
   4. A controller according to clause 3 configured to set a speed of an engine to a predetermined speed that is determined in dependence at least in part on a frequency with which enhanced charging operations are being performed.
   5. A controller according to clause 3 or clause 4 configured to set an engine speed to a predetermined value that is determined in dependence at least in part on a duration of one or more enhanced charging operations, optionally an average duration.
   6. A controller according to any one of clauses 3 to 5 configured to cause an increase in engine speed to a speed determined in dependence at least in part on a signal indicative of a driving style of a user.
   7. A controller according to clause 6, the driving style being determined at least in part in dependence on one or more selected from amongst a frequency with which a user demands an amount of drive torque requiring operation of the engine and electrical propulsion motor, a frequency with which a user actuates an accelerator control to demand an amount of drive torque not requiring operation of the electrical propulsion motor, a rate at which a user causes movement of an accelerator control to actuate an accelerator control, and a rate at which a user causes movement of an accelerator control to cause an increase in an amount of demanded drive torque.
   8. A controller according to any preceding clause configured to receive a signal indicative of a driving mode in which a vehicle is operating, wherein the first set of conditions further comprise the condition that the vehicle is operating in one of a predetermined one or more driving modes.
   9. A controller according to clause 8 wherein the signal indicative of a driving mode in which a vehicle is operating corresponds to a state of a manual driving mode selector input device or a signal indicative of a driving mode selected automatically by the controller.
   10. A motor vehicle control system comprising a controller according to any preceding clause.
   11. A control system according clause 10 as depending through clause 8 wherein the driving modes are control modes of at least one subsystem of a vehicle, the control system having a subsystem controller for initiating control of a vehicle subsystem in the selected one of the plurality of subsystem control modes, each one of the driving modes corresponding to one or more different driving conditions for a vehicle.
   12. A control system according to clause 11 wherein in each subsystem control mode the system is configured to cause at least one vehicle subsystem to be operated in a subsystem configuration mode appropriate to the driving condition.
   13. A control system according to clause 11 or clause 12 wherein the driving modes are control modes of a plurality of vehicle subsystems.
   14. A control system according to any one of clauses 11 to 13 wherein the driving modes include one or more control modes selected from the following:
control modes of at least one vehicle subsystem selected from amongst an engine management system, a transmission system, a steering system, a brakes system and a suspension system;
control modes of a suspension system and the plurality of subsystem configuration modes comprise a plurality of ride heights;
control modes of a fluid suspension system in which fluid interconnection can be made between suspensions for wheels on opposite sides of the vehicle, and wherein said plurality of subsystem configuration modes provide different levels of said interconnection;
control modes of a steering system which can provide steering assistance, and wherein said plurality of subsystem configuration modes provide different levels of said steering assistance;
control modes of a brakes system which can provide braking assistance, and said plurality of subsystem configuration modes provide different levels of said braking assistance;
control modes of a brake control system which can provide an anti-lock function to control wheel slip, and said plurality of subsystem configuration modes allow different levels of said wheel slip;
control modes of a powertrain system which includes a powertrain controller and an accelerator or throttle pedal, the subsystem configuration modes providing different levels of responsiveness of the powertrain controller to movement of the accelerator or throttle pedal;
control modes of a traction control system which is arranged to control wheel spin, and said plurality of subsystem configuration modes allow different levels of said wheel spin
control modes of a yaw control system which is arranged to control vehicle yaw, and said plurality of subsystem configuration modes allow different levels of divergence of said vehicle yaw from an expected yaw;
control modes of a range change transmission and said subsystem configuration modes may include a high range mode and a low range mode of said transmission; and
control modes of a transmission system operable in a plurality of transmission ratios and including a transmission controller arranged to monitor at least one parameter of the vehicle and to select the transmission ratios in response, and wherein the subsystem configuration modes include a plurality of transmission configuration modes in which the transmission ratios are selected differently in response to said at least one parameter.
   15. A motor vehicle comprising a controller according to any one of clauses 1 to 9 or a control system according to any one of clauses 10 to 14.
   16. A method of controlling a vehicle implemented by means of a control system comprising:
determining when a vehicle is stationary;
determining when a user has commanded application of a brake to hold a vehicle stationary; and
determining when a transmission is in a predetermined one or more operating conditions in which the transmission is configured to deliver drive torque to a driveline,
the method further comprising commanding an enhanced charging operation to be performed in which an engine-driven electrical generator is caused to generate charge to charge a propulsion charge storage device when a first set of conditions are met, the first set of conditions comprising the conditions that the vehicle is stationary, the user has commanded application of a brake to hold the vehicle stationary and a transmission is one said one or more predetermined operating conditions.
   17. A carrier medium carrying computer readable code for controlling a vehicle to carry out the method of clause 16.
   18. A computer program product executable on a processor so as to implement the method of clause 16.
   19. A computer readable medium loaded with the computer program product of clause 18.
   20. A processor arranged to implement the method of clauses 16, or the computer program product of clause 18.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A controller for a hybrid electric vehicle comprising:
charging command means for causing an engine-driven electrical generator to generate charge to charge a propulsion charge storage device;
means for determining when a vehicle is stationary;
means for determining when a user has commanded application of a brake to hold a vehicle stationary; and
means for determining when a transmission is in a predetermined one or more operating conditions in which the transmission is configured to deliver drive torque to a driveline,
wherein the controller is configured to command an enhanced charging operation to be performed in which the charging command means is configured to cause the electrical generator to generate charge when a first set of conditions are met, the first set of conditions comprising the conditions that the vehicle is stationary, the user has commanded application of a brake to hold the vehicle stationary and a transmission is in one said one or more predetermined operating conditions.

2. A controller according to claim 1 wherein the first set of conditions further comprise the condition that a state of charge (SOC) of the propulsion charge storage device is less than a predetermined value.

3. A controller according to claim 1 configured to set a speed of an engine to a predetermined speed when an enhanced charging operation is performed.

4. A controller according to claim 3 configured to set a speed of an engine to a predetermined speed that is determined in dependence at least in part on a frequency with which enhanced charging operations are being performed.

5. A controller according to claim 3 configured to set an engine speed to a predetermined value that is determined in dependence at least in part on a duration of one or more enhanced charging operations, optionally an average duration.

6. A controller according to claim 3 configured to cause an increase in engine speed to a speed determined in dependence at least in part on a signal indicative of a driving style of a user.

7. A controller according to claim 6, the driving style being determined at least in part in dependence on one or more selected from amongst a frequency with which a user demands an amount of drive torque requiring operation of the engine and electrical propulsion motor, a frequency with which a user actuates an accelerator control to demand an amount of drive torque not requiring operation of the electrical propulsion motor, a rate at which a user causes movement of an accelerator control to actuate an accelerator control, and a rate at which a user causes movement of an accelerator control to cause an increase in an amount of demanded drive torque.

8. A controller according to claim 1 configured to receive a signal indicative of a driving mode in which a vehicle is operating, wherein the first set of conditions further comprise the condition that the vehicle is operating in one of a predetermined one or more driving modes.

9. A controller according to claim 8 wherein the signal indicative of a driving mode in which a vehicle is operating corresponds to a state of a manual driving mode selector input device or a signal indicative of a driving mode selected automatically by automatic driving mode selection means.

10. A motor vehicle control system comprising a controller according to claim 1.

11. A control system according claim 10 wherein the driving modes are control modes of at least one subsystem of a vehicle, the control system having a subsystem controller for initiating control of a vehicle subsystem in the selected one of the plurality of subsystem control modes, each one of the driving modes corresponding to one or more different driving conditions for a vehicle.

12. A control system according to claim 11 wherein in each subsystem control mode the system is configured to cause at least one vehicle subsystem to be operated in a subsystem configuration mode appropriate to the driving condition.

13. A control system according to claim 11 wherein the driving modes are control modes of a plurality of vehicle subsystems.

14. A control system according to claim 11 wherein the driving modes include one or more control modes selected from the following:
control modes of at least one vehicle subsystem selected from amongst an engine management system, a transmission system, a steering system, a brakes system and a suspension system;
control modes of a suspension system and the plurality of subsystem configuration modes comprise a plurality of ride heights;
control modes of a fluid suspension system in which fluid interconnection can be made between suspensions for wheels on opposite sides of the vehicle, and wherein said plurality of subsystem configuration modes provide different levels of said interconnection;
control modes of a steering system which can provide steering assistance, and wherein said plurality of subsystem configuration modes provide different levels of said steering assistance;
control modes of a brakes system which can provide braking assistance, and said plurality of subsystem configuration modes provide different levels of said braking assistance;
control modes of a brake control system which can provide an anti-lock function to control wheel slip, and said plurality of subsystem configuration modes allow different levels of said wheel slip;
control modes of a powertrain system which includes a powertrain control means and an accelerator or throttle pedal, the subsystem configuration modes providing different levels of responsiveness of the powertrain control means to movement of the accelerator or throttle pedal;
control modes of a traction control system which is arranged to control wheel spin, and said plurality of subsystem configuration modes allow different levels of said wheel spin
control modes of a yaw control system which is arranged to control vehicle yaw, and said plurality of subsystem configuration modes allow different levels of divergence of said vehicle yaw from an expected yaw;
control modes of a range change transmission and said subsystem configuration modes may include a high range mode and a low range mode of said transmission; and
control modes of a transmission system operable in a plurality of transmission ratios and including a transmission control means arranged to monitor at least one parameter of the vehicle and to select the transmission ratios in response, and wherein the subsystem configuration modes include a plurality of transmission configuration modes in which the transmission ratios are selected differently in response to said at least one parameter.

15. A motor vehicle comprising a controller according to claim 1.

16. A method of controlling a vehicle implemented by means of a control system comprising:
determining when a vehicle is stationary;
determining when a user has commanded application of a brake to hold a vehicle stationary; and
determining when a transmission is in a predetermined one or more operating conditions in which the transmission is configured to deliver drive torque to a driveline,
the method further comprising commanding an enhanced charging operation to be performed in which an engine-driven electrical generator is caused to generate charge to charge a propulsion charge storage device when a first set of conditions are met, the first set of conditions comprising the conditions that the vehicle is stationary, the user has commanded application of a brake to hold the vehicle stationary and a transmission is in one said one or more predetermined operating conditions.

17. A carrier medium carrying computer readable code for controlling a vehicle to carry out the method of claim 16.

18. A computer program product executable on a processor so as to implement the method of claim 16.

19. A computer readable medium loaded with the computer program product of claim 18.

20. A processor arranged to implement the method of claim 16.

21. A controller for a hybrid electric vehicle comprising:
charging command means for causing an engine-driven electrical generator to generate charge to charge a propulsion charge storage device;
means for determining when a vehicle is stationary;
means for determining when a user has commanded application of a brake to hold a vehicle stationary; and
means for determining when a vehicle is in an off-road environment,
wherein the controller is configured to command an enhanced charging operation to be performed in which the charging command means is configured to cause the electrical generator to generate charge when a first set of conditions are met, the first set of conditions comprising the conditions that the vehicle is stationary, the user has commanded application of a brake to hold the vehicle stationary and the vehicle is in an off-road environment.

22. A controller according to claim 21 configured to receive a signal indicative of a driving mode in which a vehicle is operating, wherein a vehicle is determined to be in an off-road environment in dependence on the vehicle operating in one of a predetermined one or more driving modes.

23. A controller according to claim 21 configured to receive a signal from one or more sensors, the signal being indicative of a vehicle operating in an off-road environment, wherein a vehicle is determined to be in an off-road environment in dependence on said signal.

24. A controller according to claim 23 wherein said signal is received from a vehicle mounted camera, the signal being indicative of a type of terrain in the vicinity of the vehicle.

25. A controller according to claim 23 wherein the signal is received from a global positioning system (GPS) wherein the signal is indicative of the position of the vehicle.

26. A controller according to claim 21 comprising means for determining when a transmission is in a predetermined one or more operating conditions in which the transmission is configured to deliver drive torque to a driveline, wherein the first set of conditions comprises a transmission being in said one or more predetermined operating conditions.

27. A method of controlling a vehicle implemented by means of a control system comprising:
determining when a vehicle is stationary;
determining when a user has commanded application of a brake to hold a vehicle stationary; and
determining when a vehicle is in an off-road environment,
the method further comprising commanding an enhanced charging operation to be performed in which an engine-driven electrical generator is caused to generate charge to charge a propulsion charge storage device when a first set of conditions are met, the first set of conditions comprising the conditions that the vehicle is stationary, the user has commanded application of a brake to hold the vehicle stationary and the vehicle is in an off-road environment.

28. (canceled)
